(19) United States
(12) Patent Application Publication
(10) Pub. No.: US 2013/0124089 A1
(43) Pub. Date: May 16, 2013

(54) SPATIOTEMPORAL SURVIVABILITY DATA COMPRESSION USING OBJECTIVE ORIENTED CONSTRAINTS

(71) Applicants: Carl R. Herman, Owego, NY (US); James C. Rosswog, Owego, NY (US)

(72) Inventors: Carl R. Herman, Owego, NY (US); James C. Rosswog, Owego, NY (US)

(73) Assignee: Lockheed Martin Corporation

(21) Appl. No.: 13/294,580

(22) Filed: Nov. 11, 2011

(51) Int. Cl. G01C 21/00

(52) U.S. Cl. 701/528

(57) ABSTRACT

Systems and methods are disclosed for determining an optimal flight path from a starting point to a destination point within an allotted time interval. The time interval is divided into a plurality of time periods. For each time period, a plausibility region is determined, representing an area reachable by an aircraft by an end of the time period, but from which the aircraft can reach the destination point within the remaining time. An expected region of influence is determined for at least one threat at each time period, and a constituent cost map is generated by assigning a cost to cells within the overlap of the region of influence and the plausibility region. The constituent cost maps are combined into a final cost map. The optimal path is determined as a lowest cost path from the starting point to the destination point, and displayed to a user.

### BACKGROUND OF THE INVENTION

1. Technical Field

The invention relates to systems and methods for planning an optimal route for an aircraft by compressing survivability data using objective oriented constraints.

2. Description of the Prior Art

Aircraft are used in a wide variety of applications, both civilian and military, including travel, transportation, fire fighting, surveillance, and combat. Various aircraft have been designed to fill the wide array of functional roles defined by these applications, including balloons, dirigibles, traditional fixed wing aircraft, flying wings and helicopters. As aircraft have evolved, however, so have techniques and systems for neutralizing the effectiveness of aircraft, including other airborne craft as well as a number of devices that can be employed at ground level to damage an aircraft and its occupants. Given the relatively high visibility of an aircraft in flight and the structural trade-offs necessary to keep an aircraft at a proper weight for flight, it is often desirable to avoid these threats entirely where possible.

### SUMMARY OF THE INVENTION

In accordance with an aspect of the present invention, a method is provided for determining an optimal flight path for an aircraft from a starting point to a destination point within an allotted time interval. The allotted time interval is divided into a plurality of time periods. For each time period, a plausibility region is determined, representing an area in which it is possible for the aircraft to reach by an end of the time period and still be capable of reaching the destination point within a remaining time of the allotted time interval after the end of the time period. For each time period, an expected region of influence during the time period is determined for at least one threat. A constituent cost map is generated for each time period. In the constituent cost map, each cell within an overlap of the expected region of influence during the time period and the plausibility region for the time period is assigned a cost. A final cost map is generated as a combination of the associated constituent cost maps for the plurality of time periods. The optimal path is determined as a path from the starting point to the destination point having a lowest total cost, and displayed to a user.

In accordance with another aspect of the present invention, a computer readable medium, storing executable instructions for determining an optimal flight path from a starting point to a destination point within an allotted time interval, is provided. Upon execution of these instructions, a possibility region, centered on the starting point, and an objective region, centered on the destination point, are defined for each of a plurality of time periods comprising the allotted time interval. The possibility region represents a maximum distance that the aircraft can travel from the starting point by the end of the time period, and the objective region represents a maximum distance that the aircraft can travel between the end of the time period and the end of the allotted time interval.

For each time period, a plausibility region is determined as the intersection of the possibility region and the objective region, and an expected region of influence for at least one threat during the time period is determined. A constituent cost map is generated for each time period. In the constituent cost map, each cell within an overlap of the expected region of influence during the time period and the plausibility region for the time period is assigned a cost. A final cost map is generated as a combination of the associated constituent cost maps for the plurality of time periods. The optimal path is determined as a path from the starting point to the destination point having a lowest total cost.

In accordance with yet another aspect of the present invention, a system is provided for determining an optimal flight path for an aircraft from a starting point to a destination point within an allotted time interval. A plausibility region generator is configured to determine, for each of a plurality of time periods comprising the allotted time interval, a plausibility region representing an area in which it is possible for the aircraft to reach by an end of the time period and still be capable of reaching the destination point within a remaining time of the allotted time interval after the end of the time period. A threat prediction element is configured to determine, for each of the plurality of time periods, an expected region of influence for at least one threat during the time period. A cost mapper is configured to generate, for each of the plurality of time periods, a constituent cost map in which each cell within an overlap of the expected region of influence during the time period and the plausibility region for the time period is assigned a cost. A cost combiner is configured to generate a final cost map such that the value of each cell in the final cost map is a linear combination of values of corresponding cells across the constituent cost maps for the plurality of time periods. A route optimization element is configured to deteii line the optimal path as a path from the starting point to the destination point having a lowest total cost.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 illustrates a system configured to provide an optimal flight path for an aircraft in accordance with an aspect of the present invention;

FIG. 2 illustrates an exemplary implementation of a route planning system utilizing spatiotemporal data compression in accordance with an aspect of the present invention;

FIGS. 3A-3F illustrate graphically the operation of an exemplary route planning system utilizing spatiotemporal compression in accordance with an aspect of the present invention as a series of maps depicting a region of interest through which the aircraft will pass;

FIG. 4 illustrates a method for determining an optimal flight path for an aircraft from a starting point to a destination point within an allotted time interval in accordance with the present invention; and

FIG. 5 illustrates a computer system that can be employed to implement systems and methods described herein, such as based on computer executable instructions running on the computer system.

### DETAILED DESCRIPTION OF THE INVENTION

In accordance with the present invention, a route planning system is provided for determining an optimal route to allow an aircraft to travel through a hostile region from a starting point to a destination point within an allotted time by predicting the location and effectiveness of one or more threats to the aircraft. It will be appreciated that these threats can include other aircraft, ground-based vehicles, or marine craft. For the purpose of route planning, the allotted time interval can be divided into a plurality of time periods, and for each time period, an area, referred to as a plausibility region, in which the aircraft is expected to reach to stay within mission parameters. In accordance with an aspect of the present invention, the expected influence of a threat during a given time period is assigned a cost only within the plausibility region for that time period. It will be appreciated that the term “cost” is used generically herein to refer to an increase or decrease in the likelihood that an aircraft will be threatened with significant damage from a threat. The contributions from each time period can be combined into a final cost map, and from this cost map, an optimal flight plan for the aircraft can be determined.

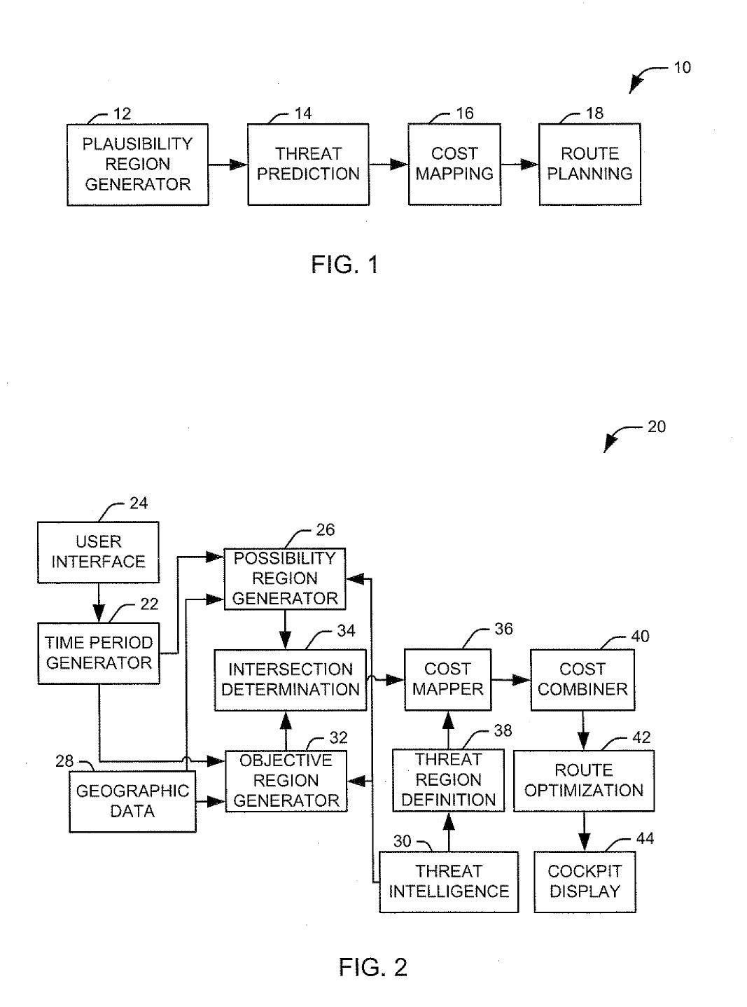

FIG. 1 illustrates a system 10 configured to provide an optimal flight path for an aircraft in accordance with an aspect of the present invention. It will be appreciated that each component 12, 14, 16, and 18 of this system can be implemented on the aircraft as part of existing navigation systems or as a standalone system connected to the aircraft by a communications link. The system 10 includes a plausibility region generator 12 that is configured to determine regions in which, given the capacity of the aircraft and the time and fuel constraints of the aircraft's flight, it is plausible for the aircraft to be located at the end of each of a plurality of time periods.

For example, the flight path of the aircraft can have a designated starting point, a designated destination point, and a maximum amount of time to travel between the two points. For each time period, a first region, having a first radius, can be defined around the starting point defining the maximum extent that it is possible for the aircraft to reach in that amount of time. The first region can be determined according to the known capabilities of the aircraft, such as maximum velocity and turning radius. A second region, having a second radius, can be defined, according to known capabilities of the aircraft, for each time period as the universe of all locations in which it is possible to reach the destination point in the time remaining after the time period. It will be appreciated that each of the first and second regions can be adjusted according to geographical features, political boundaries, and regions of significant threat concentration. The intersection of the first region and the second region is selected as the plausibility region, essentially the region in which it is possible for the around the in which it is possible for the aircraft to be present while retaining the ability to reach the destination point within allotted time.

A threat prediction component 14 determines a position and one or more effective ranges for one or more threats during each time period. For example, a current position, velocity, and direction of travel for each threat can be provided by associated sensor systems. From these parameters, and known geographical details (e.g., road paths, obstructing terrain, etc.), a path of travel for the threats can be predicted. Coupled with the known velocity and a known effective range at which the threat is likely to damage the aircraft or its occupants, a region of influence for each threat can be developed for each time period. For example, an area in which the threat is likely to be present with a threshold confidence during each time period can be defined, and expanded according to the effective range of the threat to produce a region of influence for the time period.

The projected positions and regions of likely threat can be provided to a cost mapping component 16 that, for each time period, assigns an associated cost to each of a plurality of cells within the plausibility region. A constituent cost map for each time period can be assigned according to the determined region of influence of each threat during the time period. In accordance with an aspect of the present invention, cost values are assigned to a constituent cost map for a given time period only where the region of influence of the threat coincide with the plausibility region for the time period. All influence of the threat outside of the plausibility region is ignored. Accordingly, each constituent cost map represents the impact of the one or more threats on the potential flight path of the aircraft during its associated time period.

The plurality of constituent cost maps can then be combined, for example, as a linear combination of the associated costs of corresponding cells on the plurality of cost maps to form a final cost map. The constituent cost maps can be weighted in this linear combination, for example, according to the relative period of time represented by each constituent cost map, according to parameters derived from one of more factors representing the vulnerability of the aircraft during its associated time period (e.g., airspeed, altitude, geographic features, etc.), or any other appropriate factor. It will be appreciated that, in addition to the plurality of constituent cost maps, the final cost map can be influenced by other factors, such as geographical features and political boundaries, to produce a comprehensive cost map for route planning purposes. From the final cost map, a route planning component 18 can determine an optimal flight plan for the aircraft.

FIG. 2 illustrates an exemplary implementation of a route planning system 20 utilizing spatiotemporal data compression in accordance with an aspect of the present invention. In accordance with an aspect of the present invention, the system 20 operates to plan a flight path from a designated starting point to a designated destination point within an allotted time interval. A time period generator 22 divides the allotted time interval into a plurality of time periods. For example, the time interval generator 22 can determine appropriate intervals according to the processing resources of the system, the length of the allotted time interval, the position and maximum velocity of one or more known threats, and one or more characteristics of the aircraft (e.g., velocity and altitude). It will be appreciated that the plurality of time periods can have unequal lengths, for example, to allow for a greater number of time periods in portions of the interval in which the aircraft is expected to be in closest proximity to the threat.

Alternatively, respective lengths for the time periods can be provided by an operator via a user interface 24. The user interface 24 can comprise one or more of voice recognition software for interpreting spoken commands from a user, drivers for one or more input devices, such as a touch screen, keyboard, mouse, joystick, or directional pad, and networking protocols for accepting commands from a remote operator. It will be appreciated that each of the designated starting point, the designated destination point, and the allotted time interval can be provided to the system 20 through the user interface.

In accordance with an aspect of the present invention, the effect of each threat on the flight path of the aircraft is quantified for each time period according to the position of the threat during the time period and the plausible position of the aircraft during that period. To this end, a possibility region generator 26 determines, for each of a plurality of time periods, the maximum distance that the aircraft can be expected to travel prior to the end of the time period. The possibility region can be determined according to known capabilities of the aircraft, such as maximum velocity, turning radius, maximum altitude, etc. Accordingly, the possibility region for each successive time period should grow larger. In one implementation, information from a database of known geographical data 28, including, for example, geographic features and political boundaries, and data from a database of intelligence on known threats 30, such as the position, concentration, and capabilities of known threats, can be utilized to adjust the extent of the possibility region for each time period. It will be appreciated that the threat intelligence database 30 can include information related to one or more threats (e.g., position, velocity, direction of travel, identity, etc.) gathered by sensors on the aircraft, other manned or unmanned aircraft, ground vehicles, and spacecraft, as well as through direct and indirect observations from human sources.

An objective region generator 32 determines, for each of the plurality of time periods, an objective region centered on the destination point representing the maximum distance that the aircraft can be expected to travel between the end of the time period and the end of the allotted time period. Similarly to the possibility region, the objective region can be determined according to known capabilities of the aircraft. Accordingly, the objective region for each successive time period should grow smaller. In one implementation, infoiniation from the database of geographical data 28 and the threat intelligence database 30 can be utilized to adjust the extent of the possibility region for each time period.

An intersection determination element 34 determines, for each time period, an intersection between the possibility region and the objective region for the time period. This intersection, referred to herein as the plausibility region, represents the only locations in which it is possible for the aircraft to be present and capable of reaching the destination point in the allotted time interval. In accordance with an aspect of the present invention, the cost assigned for the expected position of a threat at the time period is limited to the influence of the threat within the plausibility region for that time period. Accordingly, the determined intersection is provided to a cost mapper 36.

A threat region definition component 38 deteimines, for each time period, an expected position and region of influence for one or more threats. For example, a current position, velocity, and direction of travel for each threat can be retrieved from the threat intelligence database. From these parameters, and known geographical details (e.g., road paths, obstructing terrain, etc.), a path of travel for threats can be predicted. Coupled with the known velocity, either of a most likely location or a distribution of possible locations of a given threat can be predicted for each time period. A determined distribution and one or more ranges at which the threat can be utilized to define a plurality of subregions within the region of influence for the time period, such that all cells within a given subregion is assigned a cost associated with the region. For example, a region in which the threat is expected to be present within a threshold confidence value can be determined, and this region can be extended by a known effective range of the threat to produce a region of influence.

The cost mapper 36 determines associated cost values for each time period according to the determined plausibility region for the time period and the region of influence for the threat during the time period. Specifically, each cell within the plausibility region for the time period that falls within the region of influence for the threat is assigned an appropriate cost. As has been discussed previously, the region of influence for the threat can have a single cost associated with the entire region or a plurality of cost values associated with various subregions of the region of influence. It will be appreciated that the cost values for a given time period can be influenced by geographical features within the region of interest. For example, where a region of elevated terrain would block or hinder line of sight to a particular cell within the plausibility region from the threat, the imposed cost for that cell can be reduced or eliminated. Where regions of influence associated with multiple threats overlap, the cost assigned in the region of overlap can be determined as a linear combination of the respective cost values associated with the regions of influence.

The cost map determined for each time region is provided to a cost combiner 40 that combines the plurality of cost maps to generate a final cost map. For example, the value of each cell of the final cost map can be determined as a linear combination of the corresponding cells of the cost maps for the plurality of cost maps. In one implementation, the cost for each cell of the final cost map is simply the sum of the costs for the cell across the plurality of cost maps. In addition, specific types of terrain can cause a cost to be assessed or removed from a given cell. For example, where the elevation of a cell is higher than it is desirable for the aircraft to fly, a cost can be accessed to that cell.

Once a final cost map has been generated, a lowest cost path for the aircraft can be determined at route optimization element 42. The route optimization performs an appropriate optimization algorithm to determine a lowest cost path for the aircraft through the reroute region. For example, the lowest cost path can be determined by any of a Dijkstra's algorithm, a Bellman-Ford algorithm, an A* search algorithm, a Floyd-Warshall algorithm, or an algorithm based on perturbation theory. Once an optimal flight plan has been determined, the flight path is provided to a pilot of the aircraft on a display 44 within the cockpit.

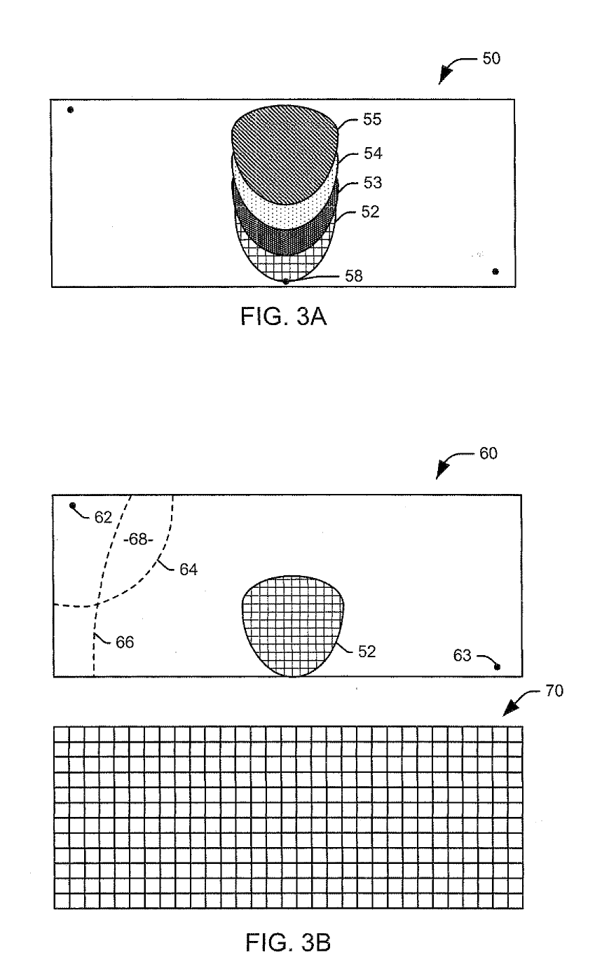

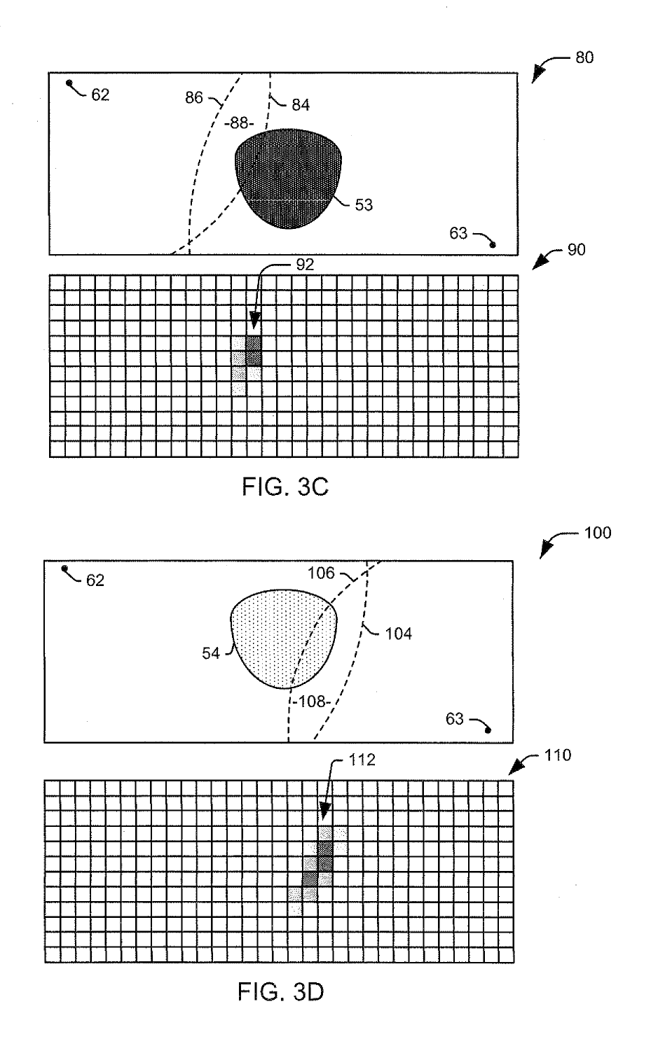

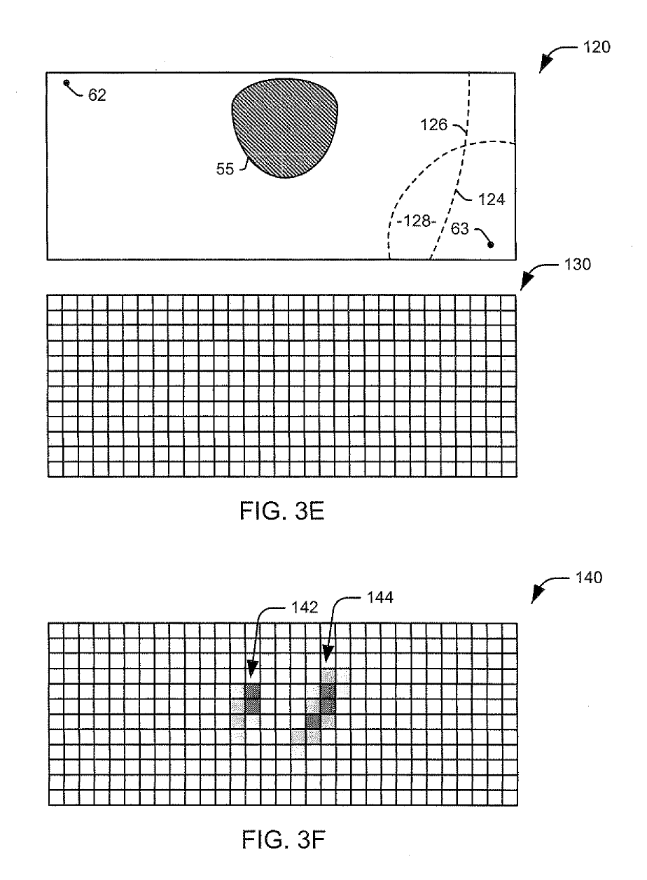

FIGS. 3A-3F illustrate graphically the operation of an exemplary route planning system utilizing spatiotemporal compression in accordance with an aspect of the present invention as a series of maps depicting a region of interest through which the aircraft will pass. Each figure depicts one step of a series of steps in the route planning process, with the number of illustrated elements maintained among steps. It will be appreciated that the illustrated steps are not necessarily inclusive, and that not all steps may be necessary in the operation of a route planning system in accordance with an aspect of the present invention. Further, the steps can take place in an order different than that depicted herein, and can be performed in parallel in some implementations.

FIG. 3A illustrates a first map 50 of the region of interest. In the illustrated region, a plurality of projected regions of influence 52-55 each represent, for a given threat 58, the area over which the threat is expected to have the capacity to damage an aircraft or its occupants at a specific time. In accordance with an aspect of the present invention, the future location of the threat and its area of influence can be predicted according to one or more of the current position and direction of motion of the threat, a current velocity of the threat, a range at which the threat can threaten an aircraft, known geographical features in the immediate vicinity of the threat, and the capabilities (e.g., maximum velocity, ability to traverse difficult or unconventional terrain, etc.) of the threat.

In the illustrated example, a first region of influence 52 represents the region threatened by the threat 58 at a first associated time relative to an initial time, a second region of influence 53 represents the region threatened by the threat at a second associated time, a third region of influence 54 represents the region threatened by the threat at a third associated time, and a first region of influence 52 represents the region threatened by the threat at a fourth associated time.

FIG. 3B illustrates a second map 60 of the region of interest at the first associated time, and a first constituent cost map 70 for the first associated time. The second map 60 illustrates a starting point 62 for the aircraft and a destination point 63 for the aircraft. It will be appreciated that the starting point 62 is simply the point at which the aircraft is deemed to be at the initial time, as opposed to an absolute starting point for the flight, and the destination point 63 is the point at which the aircraft is required to reach by a designated final time to stay within desired time and fuel parameters.

To this end, a first possibility region 64 can be defined around the starting point 62, representing the maximum distance that the aircraft could travel between the initial time and the first associated time. It will be appreciated that the first possibility region 64, while illustrated herein as a segment of a sphere, can assume an irregular shape due to geographical features, political boundaries, and regions of significant threat concentration. Similarly, a first objective region 66 can be defined around the destination point, representing the potential locations from which it is possible to reach the destination point 63 in the time remaining between the first associated time and the destination time. Like the first possibility region 64, the first objective region 66 can be influenced by geographical features, political boundaries, and regions of significant threat concentration.

The area where the first possibility region 64 and the first objective region 66 overlap is the first plausibility region 68, which encompasses every point at which it is possible for the aircraft to be present and still reach the destination point by the desired time. For the flight to be completed in the desired time, the plane must be within the first plausibility region 68 at the first associated time. In accordance with an aspect of the present invention, the first constituent cost map 70 is populated only in areas of overlap between the first plausibility region 68 and the expected region of influence 53 of the threat at the first associated time. This ensures that the influence of the threat is considered only when it is relevant to the progression of the aircraft. Since the first plausibility region 68 and the first region of influence 55 of the threat do not overlap, no cost is assigned on the first constituent cost map.

FIG. 3C illustrates a third map 80 of the region of interest at the second associated time, and a second constituent cost map 90. The second map 80 illustrates a second possibility region 84 defined around the starting point 62 representing the maximum distance that the aircraft could travel between the initial time and the second associated time and a second objective region 86 defined around the destination point 63, representing the potential locations from which it is possible to reach the destination point 63 in the time remaining between the second associated time and the destination time. Both the second possibility region 84 and the second objective region 86 can be influenced by geographical features, political boundaries, and regions of significant threat concentration.

Here, a second plausibility region 88 defined by the overlap between the second possibility region 84 and the second objective region 86. In accordance with an aspect of the present invention, the second constituent cost map 90 is populated only in cells 92 located within areas of overlap between the second plausibility region 88 and the second region of influence 53 of the threat, representing the expected influence of the threat at the second associated time. It will be appreciated that the cost assigned to each cell within the region of influence 54 of the threat can vary. For example, the region of influence of the threat can be divided into multiple discrete subregions, and each subregion can provide a different cost to the cells that it covers. For example, the probability that the threat 52 can damage the aircraft will increase with proximity to the aircraft, so the cost will increase with distance from the threat. Alternatively, the location of the threat 52 can vary probabilistically, and the cost assigned can vary according to the likelihood that the threat will be within a predetermined range of the threat.

It will be appreciated that the cost can be modified due to intervening geographical features or weather conditions that occlude the sightline from the threat to the aircraft. Similarly, the cost can be reduced when effectiveness of the threat is reduced relative to other positions within range of the aircraft. For example, when the target is at a poor angle for targeting the aircraft (e.g., substantially perpendicular to the flight path of the aircraft), its imposed cost can be reduced.

FIG. 3D illustrates a fourth map 100 of the region of interest at the third associated time, and a third constituent cost map 110. The third map 100 illustrates a third possibility region 104 defined around the starting point 62 representing the maximum distance that the aircraft could travel between the initial time and the third associated time and a third objective region 106 defined around the destination point 63, representing the potential locations from which it is possible to reach the destination point 63 in the time remaining between the third associated time and the destination time. Both the third possibility region 104 and the third objective region 106 can be influenced by geographical features, political boundaries, and regions of significant threat concentration.

Here, a third plausibility region 108 defined by the overlap between the third possibility region 104 and the third objective region 106. In accordance with an aspect of the present invention, the third constituent cost map 110 is populated only in cells 112 located within areas of overlap between the third plausibility region 108 and the third region of influence 54, representing the expected influence of the threat at the third associated time. Accordingly, the third constituent cost map 110 reflects the influence of the threat on the possible locations of the aircraft at the third associated time.

FIG. 3E illustrates a fourth map 120 of the region of interest at the fourth associated time, and a fourth constituent cost map 130. The fourth map 120 illustrates a fourth possibility region 124 defined around the starting point 62 representing the maximum distance that the aircraft could travel between the initial time and the fourth associated time and a fourth objective region 126 defined around the destination point 63, representing the potential locations from which it is possible to reach the destination point 63 in the time remaining between the fourth associated time and the destination time. Both the fourth possibility region 124 and the fourth objective region 126 can be influenced by geographical features, political boundaries, and regions of significant threat concentration. A fourth plausibility region 128 defined by the overlap between the fourth possibility region 124 and the fourth objective region 126, does not overlap the fourth region of influence 55, representing the expected influence of the threat at the fourth associated time, so no cost is assigned on the fourth constituent cost map.

FIG. 3F illustrates a final cost map 140 for the region of interest. The final cost map 140 is formed from a linear combination of the first 70, second 90, third 110, and fourth 130 constituent cost maps. In the illustrated example, the final cost map is simply the sum of the constituent cost maps 70, 90, 110, and 130. Accordingly, for the purpose of this simplified example, the final cost map 140 has a first grouping of cells 142 representing a cost contributed by the second constituent cost map 90 and a second grouping of cells 144 representing a cost contributed by the third constituent cost map 110. It will be appreciated, however, that in practice many more constituent cost maps will be utilized and that multiple constituent costs maps will be expected to contribute to the cost associated with a given cell. It will further be appreciated that the final cost map can include cost other sources as well, such as nearby geographical features or other potential hazards to the aircraft.

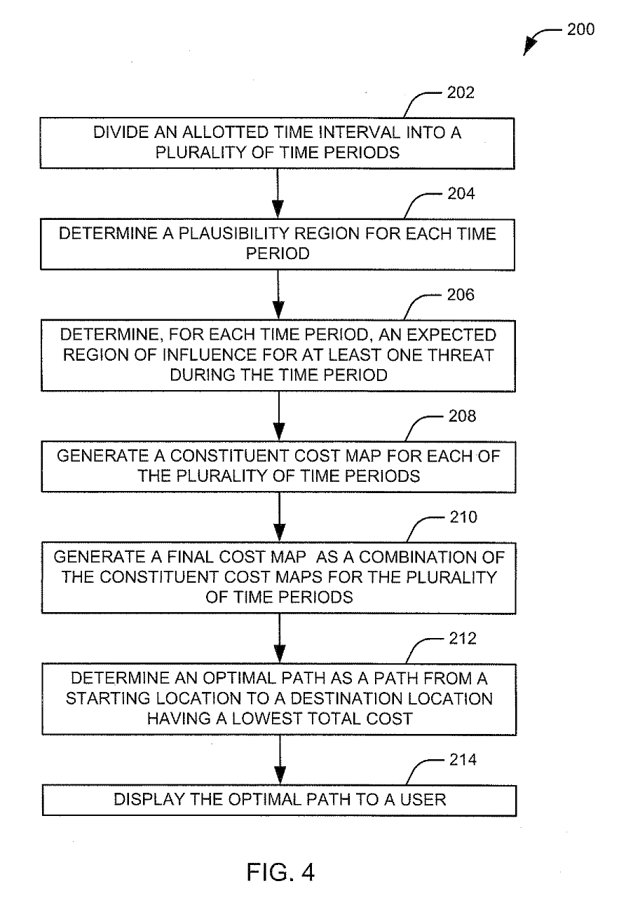

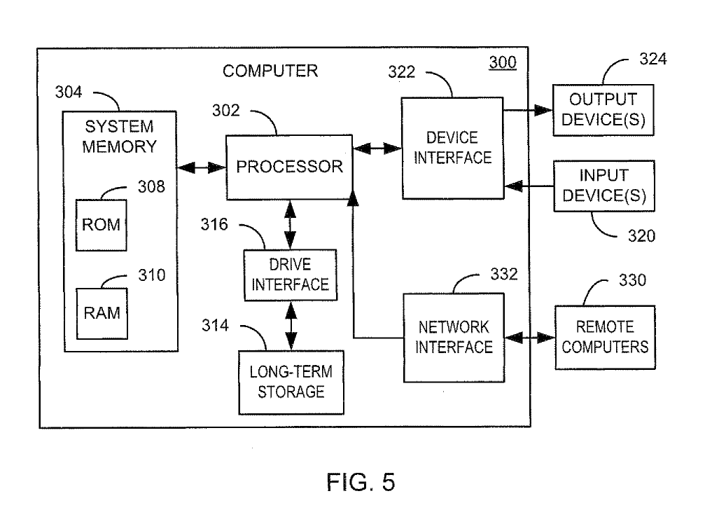

In view of the foregoing structural and functional features described above, a methodology in accordance with various aspects of the present invention will be better appreciated with reference to FIG. 4. While, for purposes of simplicity of explanation, the methodology of FIG. 4 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 4 illustrates a method 200 for determining an optimal flight path for an aircraft froze. a starting point to a destination point within an allotted time interval in accordance with the present invention. At 202, the allotted time interval is divided into a plurality of time periods. For example, appropriate time intervals can he determined according to the processing resources of the system, the length of the allotted time interval, the position and maximum velocity of one or more known threats, and one or more characteristics of the aircraft (e.g., velocity and altitude). It will be appreciated that the time intervals can be of unequal duration.

At 204, a plausibility region, representing an area in which it is possible for the aircraft to reach by an end of the time period and still be capable of reaching the destination point within a remaining time of the allotted time interval after the end of the time period, is determined for each time period. In one implementation, each time period can have a defined possibility region, centered on the starting point, that represents a maximum distance that the aircraft can travel from the starting point by the end of the time period, and a defined objective region, centered on the destination point, that represents a maximum distance that the aircraft can travel between the end of the time period and the end of the allotted time interval. The plausibility region is determined for the time period as the intersection of the possibility region and objective region. Each of the possibility region and the objective region can be modified according to at least one of political boundaries, regions of significant threat concentration, and geographical features to ensure that the plausibility region does not include areas in which it is not practical for the aircraft to travel.

At 206, for each time period, an expected region of influence for at least one threat during the time period is determined. It will be appreciated the region of influence can include multiple subregions having different associated cost values. In one implementation, a probability region can be generated in which the likelihood of the threat being present during the time period exceeds a threshold value. The probability region can be determined according to a prediction of the position of the threat during the time period according to the direction of travel of the threat, the known capabilities of the threat, and at least one geographical feature in the region of interest. For example, information related to a threat can be determine at sensors on or affiliated with the aircraft and recorded in a threat intelligence database. Information can be retrieved from this database and utilized for predicting the position of the threat. The probability region can then be extended by a known effective range of the threat to provide a region of influence.

At 208, a constituent cost map is generated for each of the plurality of time periods. For each cost map, a cost is assigned to each cell within an overlap of the expected region of influence during the time period and the plausibility region for the time period. Where multiple subregions are present in the region of influence, a first cost value can be assigned to each cell within an overlap of the plausibility region and the first subregion, and a second cost value can be assigned to each cell within the overlap of the second subregion and the plausibility region.

A final cost map is generated as a combination of the associated constituent cost maps for the plurality of time periods at 210. For example, the value of each cell in the final cost map is a linear combination of values of corresponding cells across the constituent cost maps for the plurality of time periods. The weights for the linear combination can be functions of the duration of each time period, generated according to a likelihood that a threat will be within a threshold distance of the aircraft, or generated through any appropriate means. Other methods for combining the plurality of cost maps can also be utilized. In one implementation, an additional cost can be assigned to at least one cell of the final cost map according to nearby geographical features.

At 212, an optimal path is determined as a path from a starting location to a destination location having a lowest total cost. For example, the lowest cost path can be determined by any of a Dijkstra's algorithm, a Bellman-Ford algorithm, an A* search algorithm, a Floyd-Warshall algorithm, or an algorithm based on perturbation theory. In one implementation, the optimal flight plan is constrained such that the optimal path must pass through each of the plurality of subregions. The optimal path is then displayed to a user, such as a pilot viewing a cockpit display, at 214.

FIG. 5 illustrates a computer system 300 that can be employed to implement systems and methods described herein, such as based on computer executable instructions running on the computer system. The computer system 350 can be implemented on one or more general purpose networked computer systems, embedded computer systems, routers, switches, server devices, client devices, various intermediate devices/nodes and/or stand alone computer systems. Additionally, the computer system 300 can be implemented as part of the computer-aided engineering (CAE) tool running computer executable instructions to perform a method as described herein.

The computer system 300 includes a processor 302 and a system memory 304. Dual microprocessors and other multi-processor architectures can also be utilized as the processor 350. The processor 302 and system memory 304 can be coupled by any of several types of bus structures, including a memory bus or memory controller, a peripheral bus, and a local bus using any of a variety of bus architectures. The system memory 304 includes read only memory (ROM) 308 and random access memory (RAM) 310. A. basic input/output system (BIOS) can reside in the ROM 308, generally containing the basic routines that help to transfer information between elements within the computer system 300, such as a reset or power-up.

The computer system 300 can include one or more types of long-term data storage 314, including a hard disk drive, a magnetic disk drive, (e.g., to read from or write to a removable disk), and an optical disk drive, (e.g., for reading a CD-ROM or DVD disk or to read from or write to other optical media). The long-term data storage can be connected to the processor 302 by a drive interface 316. The long-term storage components 314 provide nonvolatile storage of data, data structures, and computer-executable instructions for the computer system 300. A number of program modules may also be stored in one or more of the drives as well as in the RAM. 310, including an operating system, one or more application programs, other program modules, and program data.

A user may enter commands and information into the computer system 300 through one or more input devices 320, such as a keyboard or a pointing device (e.g., a mouse). These and other input devices are often connected to the processor 302 through a device interface 322. For example, the input devices can be connected to the system bus by one or more a parallel port, a serial port or a universal serial bus (USB). One or more output device(s) 324, such as a visual display device or printer, can also be connected to the processor 302 via the device interface 322.

The computer system 300 may operate in a networked environment using logical connections (e.g., a local area network (LAN) or wide area network (WAN) to one or more remote computers 330. A given remote computer 330 may be a workstation, a computer system, a router, a peer device or other common network node, and typically includes many or all of the elements described relative to the computer system 300. The computer system 300 can communicate with the remote computers 330 via a network interface 332, such as a wired or wireless network interface card or modem. In a networked environment, application programs and program data depicted relative to the computer system 300, or portions thereof, may be stored in memory associated with the remote computers 330.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim the following:

1. A method for determining an optimal flight path for an aircraft from a starting point to a destination point within an allotted time interval, comprising:
dividing the allotted time interval into a plurality of time periods;
determining, for each time period, a plausibility region representing an area in which it is possible for the aircraft to reach by an end of the time period and still be capable of reaching the destination point within a remaining time of the allotted time interval after the end of the time period;
determining, for each time period, an expected region of influence for at least one threat during the time period;
generating, for each of the plurality of time periods, a constituent cost map in which each cell within an overlap of the expected region of influence during the time period and the plausibility region for the time period is assigned a cost;
generating a final cost map as a combination of the associated constituent cost maps for the plurality of time periods;
determining the optimal path as a path from the starting point to the destination point having a lowest total cost; and
displaying the determined optimal path to a user.

2. The method of claim 1, wherein deter inning an expected region of influence for a given threat for a given time period comprises generating a probability region in which the likelihood of the threat being present during the time period exceeds a threshold value and extending the probability region by a known effective range of the threat.

3. The method of claim 1, wherein detennining an expected region of influence for a given threat for a given time period comprises predicting the position of the threat during the time period according to the direction of travel of the threat, the known capabilities of the threat, and at least one geographical feature in the region of interest.

4. The method of claim 1, wherein generating a final cost map further comprises assigning an additional cost to at least one cell of the final cost map according to nearby geographical features.

5. The method of claim 1, wherein determining a plausibility region for a given time period comprises:
defining a possibility region for the time period, centered on the starting point, that represents a maximum distance that the aircraft can travel from the starting point by the end of the time period;
defining an objective region for the time period, centered on the destination point, that represents a maximum distance that the aircraft can travel between the end of the time period and the end of the allotted time interval; and
determining the plausibility region for the time period as the intersection of the possibility region and objective region.

6. The method of claim 5, further comprising modifying each of the possibility region and the objective region according to at least one of political boundaries, regions of significant threat concentration, and geographical features.

7. The method of claim 1, wherein generating a final cost map comprises generating a final cost map such that the value of each cell in the final cost map is a linear combination of values of corresponding cells across the constituent cost maps for the plurality of time periods.

8. The method of claim 1, wherein displaying the determined optimal path to a user comprises displaying the determined optimal path to a pilot of the aircraft within a cockpit of the aircraft.

9. The method of claim 1, wherein the expected region of influence comprises a first subregion and a second subregion, and generating a constituent cost map for a given time period comprises assigning a first cost value to each cell within an overlap of the plausibility region and the first subregion and assigning a second cost value to each cell within the overlap of the second subregion and the plausibility region.

10. The method of claim 1, further comprising:
sensing information related to a threat at an sensor; and
recording the sensed information in a threat intelligence database;
wherein determining, for each time period, an expected region of influence for at least one threat comprises retrieving information from the threat intelligence database.

11. A computer readable medium, storing executable instructions for determining an optimal flight path from a starting point to a destination point within an allotted time interval, such that when provided to and executed by a computer processor, the executable instructions are configured to perform the following functions:
defining, for each of a plurality of time periods comprising the allotted time interval, a possibility region, centered on the starting point, that represents a maximum distance that the aircraft can travel from the starting point by the end of the time period;
defining, foreach of the plurality of time periods, an objective region, centered on the destination point, that represents a maximum distance that the aircraft can travel between the end of the time period and the end of the allotted time interval;
determining a plausibility region for each of the plurality of time periods as the intersection of the possibility region and the objective region;
determining, for each of the plurality of time periods, an expected region of influence for at least one threat during the time period;
generating, for each of the plurality of time periods, a constituent cost map in which each cell within an overlap of the expected region of influence during the time period and the plausibility region for the time period is assigned a cost;
generating a final cost map as a combination of the associated constituent cost maps for the plurality of time periods; and
determining the optimal path as a path from the starting point to the destination point having a lowest total cost.

12. The computer program product of claim 11, the executable instructions further comprising executable instructions for displaying the optimal path at an associated display.

13. The computer program product of claim 11, the executable instructions being configured such that determining an expected region of influence for a given threat for a given time period comprises generating a probability region in which the likelihood of the threat being present during the time period exceeds a threshold value and extending the probability region by a known effective range of the threat.

14. The computer program product of claim 11, the executable instructions being configured such that determining an expected region of influence for a given threat for a given time period comprises predicting the position of the threat during the time period according to the direction of travel of the threat, the known capabilities of the threat, and at least one geographical feature in the region of interest.

15. The computer program product of claim 11, the executable instructions being configured such that generating a final cost map comprises generating a final cost map such that the value of each cell in the final cost map is a linear combination of values of corresponding cells across the constituent cost maps for the plurality of time periods.

16. A system for determining an optimal flight path for an aircraft from a starting point to a destination point within an allotted time interval, comprising:
a plausibility region generator configured to determine, for each of a plurality of time periods comprising the allotted time interval, a plausibility region representing an area in which it is possible for the aircraft to reach by an end of the time period and still be capable of reaching the destination point within a remaining time of the allotted time interval after the end of the time period;
a threat prediction element configured to determine, for each of the plurality of time periods, an expected region of influence for at least one threat during the time period;
a cost mapper configured to generate, for each of the plurality of time periods, a constituent cost map in which each cell within an overlap of the expected region of influence during the time period and the plausibility region for the time period is assigned a cost;
a cost combiner configured to generate a final cost map such that the value of each cell in the final cost map is a combination of values of corresponding cells across the constituent cost maps for the plurality of time periods; and
a route optimization element configured to determine the optimal path as a path from the starting point to the destination point having a lowest total cost.

17. The system of claim 16, wherein at least one of the plausibility region generator, the threat prediction element, the cost mapper, the cost combiner, and the route optimization element are implemented on the aircraft.

18. The system of claim 16, further comprising a cockpit display that receives data representing the optimal path from the route optimization element and displays the determined optimal path to a pilot of the aircraft.

19. The system of claim 15, the plausibility region generator comprising:
a possibility region generator configured to, for each of the plurality of time periods, define a possibility region, centered on the starting point, that represents a maximum distance that the aircraft can travel from the starting point by the end of the time period;
an objective region generator configured to, for each of the plurality of time periods, define an objective region, centered on the destination point, that represents a maximum distance that the aircraft can travel between the end of the time period and the end of the allotted time interval; and
an intersection generator configured to determine the plausibility region for each of the plurality of time periods as the intersection of the possibility region and objective region for the time period.

20. The system of claim 16, the cost combiner being configured to assign an additional cost to at least one cell of the final cost map according to nearby geographical features.
